(19) United States
(12) Patent Application Publication
(10) Pub. No.: US 2025/0258011 A1
(43) Pub. Date: Aug. 14, 2025

(54) METHOD FOR CREATING AN ENVIRONMENT MAP, SELF-PROPELLED MOBILE APPLIANCE, AND COMPUTER PROGRAM

(71) Applicant: BSH Hausgeräte GmbH, München (DE)

(72) Inventors: Frank SCHNITZER, Bad Neustadt (DE); Kristina DANIEL, Bad Neustadt (DE); Kai SCHMITT, Saal (DE)

(21) Appl. No.: 19/052,569

(22) Filed: Feb. 13, 2025

(30) Foreign Application Priority Data
Feb. 14, 2024 (DE) 10 2024 201 359.5

(51) Int. Cl. G01C 21/00; A47L 9/28; A47L 11/40; G06T 3/4038; G06V 20/56

(52) U.S. Cl. CPC G01C 21/383; A47L 9/2805; A47L 11/4011; G01C 21/3837; G06T 3/4038; G06V 20/56

(57) ABSTRACT

An environment map is created of a surrounding area for the operation of a mobile self-propelled appliance, such as a floor cleaning appliance being a robot vacuum cleaner and/or robot sweeper and/or mopping robot, by: Capturing images of a floor area of a grid cell of the surrounding area using a camera of the appliance; transforming the images to generate bird's eye view first image representations; combining the first image representations with weighted averaging and inserting a first averaged image representation of the floor area into the environment map, including the appliance position and orientation; capturing an n^{th} image of the floor area of the grid cell and transforming the n^{th} image into a second image representation; combining the first and second image representations of the grid cell while performing weighted averaging of all image representations; and overwriting the first averaged image representation in the environment map with a second averaged image representation.

### CROSS-REFERENCE TO RELATED APPLICATION

This application claims the priority, under 35 U.S.C. § 119, of German Patent Application DE 10 2024 201 359.5, filed Feb. 14, 2024; the prior application is herewith incorporated by reference in its entirety.

### FIELD AND BACKGROUND OF THE INVENTION

The invention relates to a method for creating an environment map of a surrounding area for the operation of a mobile self-propelled appliance, in particular a floor cleaning appliance such as a robot vacuum cleaner and/or robot sweeper and/or mopping robot, a mobile self-propelled appliance, a computer program product and also a computer readable data carrier.

Mobile self-propelled appliances such as, for example, robot vacuum cleaners have the task of cleaning an entire floor surface as autonomously as possible. In particular, they should relieve their users of complex, repetitive floor cleaning tasks. The robots regularly perform cleaning jobs or are sent by the user to a defined floor area for cleaning. For this purpose, the cleaning robot is operated via an app on, for example, a smartphone with a displayed environment map. This environment map usually shows the floor plan of the living area with the walls, furniture and objects contained therein as contours.

The representation in the environment map usually refers to delimiting walls and contours of objects, so that a kind of floor plan of the living area is displayed. Apart from their contours and their relative position to each other, different rooms can often not be distinguished from each other.

In order to enable the user to better recognize real locations in the app's environment map and thus provide easier operation of the robot, illustrated maps can be used. Here, camera images of the robot are recorded and used step by step to realize a floor representation in the app. The environment map is thus displayed realistically in the app by integrating the image representations of the robot.

The conversion of the camera images of the robot into the map images for the app is conventionally based on a transformation that assumes that the floor that is captured by the robot by way of the camera is completely flat and the robot and thus the camera always have an unchanged orientation, for example tilting direction. Ground unevenness and pitching movements of the robot while driving can lead to distortions in the map images, which can vary depending on the situation and direction of travel.

Further influences on the image representations can include changing illumination states, such as daylight or artificial light, reflections or glare. Such situations can also have negative effects on the illustrated map, for example if floor surfaces are displayed in parts with different brightnesses.

In addition, there is the risk of a deterioration of the illustrated map or of fluctuations in the image quality if already existing image representations of the environment maps are simply replaced with newly recorded image representations, since it cannot be guaranteed that the newly recorded image representations have a better image quality than the already existing image representations.

German published patent application DE 10 2018 132 428 A1 and its counterpart U.S. Patent No. U.S. Pat. No. 10,638,906 B2 disclose a photomosaic floor mapping by the robot in which images of the robot camera are converted into a bird's eye view by transformation. The field of view of the camera is captured as an image, cut to a part or a segment, converted into a planar view and stitched together with other images. A composite illustrated map is created without the involvement of the user. In order to ensure high image quality, the quality of each recorded image is determined and, in the case of multiple captured identical segments for which there are multiple versions with different qualities, the version of low quality is replaced by a version of higher quality. However, by purely replacing one version of a segment with another version, disadvantageously visible fluctuations in the image content (for example, the brightness) can occur, which can reduce the overall quality of the environment map.

### SUMMARY OF THE INVENTION

It is accordingly an object of the invention to provide a method of creating an environment map which overcomes the above-mentioned and other disadvantages of the heretofore-known devices and methods of this general type and which provides for an improved method for creating an environment map, in which a stable continuity of the map image representations over time is rendered possible, and in which the quality of the illustrated environment map can be increased during its creation and during its further (continuous) updating.

With the above and other objects in view there is provided, in accordance with the invention, a method of creating an environment map of a surrounding area for an operation of a mobile self-propelled appliance by way of a camera of the appliance and a processing facility of the appliance, the method comprising the following steps:
a) capturing images of a floor area of a grid cell of the surrounding area using the camera;
b) transforming the images using known parameters of the camera, a position and an orientation of the camera on the appliance, to generate bird's-eye view first image representations of the floor area of the grid cell;
c) combining the first image representations while performing weighted averaging and inserting a first averaged image representation of the floor area into the environment map, including an appliance position and orientation in relation to the environment map;
d) capturing at least an n^{th} image of the floor area of the grid cell and transforming the n^{th} image into a second image representation;
e) combining the first and second image representations of the grid cell while performing a weighted averaging of all image representations; and
f) overwriting the first averaged image representation in the environment map with a second averaged image representation.

In other words, the objects of the invention are achieved with a method for creating an environment map of a surrounding area for the operation of a mobile self-propelled appliance, in particular a floor cleaning appliance such as a robot vacuum cleaner and/or robot sweeper and/or mopping robot, by means of a camera of the appliance and a processing facility of the appliance.

The quality of the illustrated environment map can advantageously be increased by the method in accordance with the invention during its creation and during its further (continuous) updating. This results in visibly better representations of the floor area with less distortion, less illumination-dependent brightness changes and thus with an overall more consistent coherent image area.

The appliance has a plurality of sensors with which it perceives its environment, inter alia a LIDAR sensor, which is used to create the environment map with the contours of walls and obstacles. In addition, the appliance has at least one camera that can detect objects in front of the appliance and is used, for example, for object recognition and classification. The field of view (FoV) of the camera also captures sections of the floor. These parts of the image can be used to perform a photomosaic floor mapping. The image contents are transformed using known parameters of the camera and its position and orientation on the appliance in such a manner that they correspond to a bird's-eye view of the recorded floor area. Taking into account the appliance position and orientation in relation to the environment map at the time of image recording, the corresponding partial area in the map representation can be filled with the image representations.

The appliance captures a plurality of images with the camera from changing directions, with different lighting conditions and sometimes with different pitch angles, for example due to floor unevenness, obstacles to be overcome, door thresholds, and the like. In order to combine these images into a resulting floor area, a weighted averaging of previous and new image representations for the floor area is performed. Instead of overwriting the image representations for a currently recorded area of the floor completely with new image representations, previous and new representations are merged. The more often a floor section is captured with the camera, the more stable the image representations that are stored for this area remain. Since the appliance captures the floor area on multiple occasions over time, isolated incorrect recordings due to pitching movements or unfavorable light glare do not impair the overall presentation. Isolated “problem images” have little effect or are suppressed in a timely manner. In addition, illumination conditions, such as daylight or artificial light from lamps, are averaged automatically, and different perspectives are averaged.

A mobile self-propelled appliance is to be understood in particular as a floor cleaning appliance which, in particular autonomously, processes floor surfaces in the household area. These include, inter alia, robot vacuum cleaners and/or robot sweepers and/or mopping robots such as, for example, robot vacuum cleaners. These appliances work in operation (cleaning operation) preferably without or with as little user intervention as possible. For example, the appliance automatically travels into a predetermined room in order to clean the floor in accordance with a predetermined and programmed method strategy.

The floor area to be processed is to be understood as any room area to be cleaned. This includes, inter alia, partial areas of individual rooms, individual areas of a home, individual rooms of a home and/or the entire floor area of the entire home or living space.

A grid cell is to be understood in particular as a subregion of the surrounding area. In particular, the surrounding area is a plurality of grid cells that are identical or at least similar, in particular in their size, shape, orientation, and the like.

An environment map is to be understood in particular as any map which is suitable for representing the environment of the floor processing area with all its walls, obstacles and items. For example, the environment map shows the floor processing area having the furniture and walls contained therein in a sketch-like manner.

Obstacles are to be understood as any objects and/or items that are arranged in a floor processing area, for example lie or stand there, and influence, in particular hinder and/or disturb, the processing by the mobile self-propelled appliance, such as, for example, furniture, walls, curtains, carpets, and the like.

The environment map having the obstacles is preferably displayed in an app on a preferably portable input apparatus. This is used in particular to visualize a possible interaction for the user.

In the present case, an input apparatus is to be understood in particular as any device which is portable for a user, which is arranged outside the mobile self-propelled appliance, in particular externally and/or differentiated from the mobile self-propelled appliance, and is suitable for displaying, providing, communicating and/or transmitting data by means of the interface, such as, for example, a cell phone, a smartphone, a tablet and/or a computer or laptop.

The app, in particular a control app for the appliance and/or a cleaning app, is installed on the input apparatus and is used for the communication of the mobile self-propelled appliance with the input apparatus and in particular renders possible a visualization of the floor processing area, in other words the living room to be cleaned or the home or living area to be cleaned. The app preferably shows the user the area to be cleaned as an environment map and also any obstacles.

A camera is to be understood in particular as any image recording apparatus which is suitable for recording images of its environment, preferably with high image quality. In this case, the camera is part of the appliance and in particular is integrated therein.

The camera captures (n-1) images of a floor area of a grid cell of the surrounding area, wherein n is an integer greater than 1. With a further time delay, the camera captures the n^{th} image and optionally further images of the floor area of the same grid cell.

A processing facility is to be understood in particular as any facility which is suitable for processing, assembling, storing, transforming and/or rewriting image representations. The processing facility is part of the appliance and in particular is integrated therein. The (n-1) images are transformed by means of the processing facility in such a manner that bird's-eye view first image representations of the floor area of the grid cell are generated. With a further time delay, the processing facility transforms the n^{th} image and optionally further images, which are captured, into the second image representation. In addition, the processing facility subsequently combines the first and second image representations of the grid cell and thus updates the averaged image representation of the environment map by overwriting. Any image representations are also preferably stored in the processing facility, in particular in a memory of the processing facility.

In one advantageous embodiment, the surrounding area is divided into a plurality of grid cells, wherein the method steps a) to f) are performed in each grid cell. By dividing the surrounding area preferably completely into grid cells, a realistic mapping of the entire flooring of the surrounding area can advantageously be ensured. In this way, the long-term stability of the image representations in the entire surrounding area can be guaranteed. The entire surrounding area can be displayed with high accuracy and detail.

In a further advantageous embodiment, the (n-1) images are captured during an exploration trip and/or cleaning trip and the n^{th} image and optionally further images are captured during a subsequent cleaning trip. After commissioning, the appliance is sent on an exploration trip by the user, during which the appliance explores the environment, creates its environment map and at the same time integrates the floor area as an illustrated map into the environment map. Already during the creation of the illustrated map and possibly also later during subsequent cleaning trips, the camera of the appliance records the (n-1) images of the floor surfaces. The n^{th} image and any subsequent images are recorded during a subsequent cleaning trip and are used to update the environment map, taking into account the weighted averaging of all previous image representations.

In a further advantageous embodiment, the (n-1) images are captured from changing directions, with different lighting conditions and/or with different pitch angles. These recorded (n-1) images are combined in order to reduce the weighting of incorrect recordings, so that they hardly affect the overall representation of the floor area. The n^{th} image and further subsequent images are preferably also captured from changing directions, with different lighting conditions and/or with different pitch angles.

In a further advantageous embodiment, the second averaged image representation results from the first averaged image representation multiplied by the number of captured first image representations, the result is added to the second image representation and this result is divided by n, wherein n is an integer greater than 1. The following formula therefore results:

$${B}_{nij , ij} = [ ( {B}_{( n - 1 ) ij , ij} * {( n - 1 )}_{ij} ) + {D}_{nij , ij} ] : {n}_{ij}$$

where Dₙ are new image representations of the camera, Bn are averaged image representations that are stored in the memory, ij is the index of a grid cell and nᵢⱼ is the number of captures of this grid cell. This results in a combination of the image representations for a grid cell. In sections of the floor area that are captured particularly often with the camera, isolated problem images have little effect on the overall result or are suppressed in a timely manner. An automatic averaging of illumination conditions and of different perspectives can be advantageously generated. In the image representations, not only the previous image representations (B) of each grid cell are stored, but also the number of previous (n-1) captures of each grid cell.

In a further advantageous embodiment, the first and second image representations comprise the color channels and/or color settings to which the weighted averaging is applied. For a color representation of the image representations, the formula is applied, for example, individually to the color channels (RGB) and/or the color settings (HSV).

In a further advantageous embodiment, the capturing of the (n-1) images is limited to a maximum value, so that new image representations retain a certain influence even after many captures. This allows, inter alia, changes in the home to be slowly incorporated into the image representations of the environment map. In particular, a weighting of the first averaged image representation is capped. This means that if n-1+x images are recorded, they count in the first averaged image representation, but the weighting is not set to n-1+x, but instead to n-1.

In particular, the weighting by means of the number of previous captures can lead to changes in the home, such as a change of furniture, being hardly or only very slowly incorporated into the image representations. By performing a reset, the user can be given the opportunity to set the weighting factor n-1 (number of captured first image representations) to 1 or 0, so that new image representations have a greater influence, or old image representations may be overwritten once, without necessarily deleting the entire environment map, whereby unchanged areas can continue to be left in the environment map. Such a reset does not necessarily have to be applied to the entire floor area, but can be applied to only selected areas of the environment map via the function in the app. Alternatively, the user can have the appliance perform a new exploration trip.

In a further advantageous embodiment, the second averaged image representation is influenced by similarities between the first image representations and the second image representation. In the present case, not only the number of previous captures of a grid cell in the image representations are considered, but also the similarities of the new image representations and the previous image representations. The above-mentioned formula thus changes, for example, as follows:

$${B}_{nij , ij} = [ {B}_{( n - 1 ) ij , ij} + ( {D}_{nij , ij} * {W}_{Dn , ij )} ] : ( 1 + {W}_{Dn , ij} )$$

$${W}_{Dn , ij} = F : [ {( n - 1 )}_{ij} * ( {D}_{nij , ij} - {B}_{( n - 1 ) ij , ij} ) ]$$

where W_{on,ij} is a weighting based on the number of previous image representations and the difference between the image representations; F can be any factor, wherein F>0 and preferably F=1.

If the similarity is determined not only via the difference to the previous image representations, but on the basis of a distribution of all previous image representations, the standard deviation of the image representations is used. The weighting factor is then, for example, as follows:

$${W}_{Dn , ij} = F : [ {σ}_{nij , ij} * ( {D}_{nij , ij} - {μ}_{nij , ij} ) ]$$

where σ_{nij,ij} is a standard deviation over all image representations (previous and prevailing) and μ_{nij,ij} is a mean value over all image representations (previous (first) and prevailing (second)) for a grid cell; F can be any factor, wherein F>0 and preferably F=1.

The less similar the image representations of the different times for a grid cell, the lower the weighting for the new image representations. If a floor area is thus repeatedly captured in the same way, this has a stabilizing effect on the illustrated environment map. Short-term disturbances can advantageously be suppressed.

In a further advantageous embodiment, the appliance moves along boundary lines of the floor area when capturing the (n-1) images, the n^{th} image and further subsequent images. In particular, the appliance does not travel transversely to the boundary lines. Boundary lines arise, for example, at the edges of carpets or between floor surfaces of different floorings, such as at a transition between parquet and tiles. If the appliance travels at an angle or transversely to these boundary lines, the transition can be perceived differently in each case from the different directions, for example by the physical height of a carpet, so that for the appliance the carpet edge appears flatter from the carpet than from the adjacent flooring, which can cause distortions in the image representations. If, on the other hand, the appliance travels along the boundary lines, these distortions can be counteracted.

In a further advantageous embodiment, the environment map is processed by image processing means. Preferably, after the exploration trip or additionally thereafter at certain time intervals, the appliance examines the created illustrated environment map using the image processing means. Due to morphological operations such as region growing, erosion, dilation and/or closing, it is possible to open up contiguous areas, which are preferably assigned to a specific flooring. In a further or alternative step, edge extraction algorithms such as Canny algorithm or Sobel operator can be applied in order to establish striking boundary lines in the image representations. In a further optional processing step, a determination of geometric shapes, such as lines and circles, can be performed, for example, by a Hough transformation.

The detection of the existing boundary lines can be further improved by using additional sensors. For example, an ultrasonic sensor that is installed in the appliance can draw conclusions about the type of flooring. An acceleration sensor or gyroscope can detect the inclination of the appliance when travelling over a boundary line (for example a carpet edge). The current consumption of the travel drives of the appliance, the brush roller motor, the side brush motors or another actuator in contact with the ground can provide information about changes in the ground underneath. Any combination of the methods mentioned can also be used.

The appliance then evaluates the image representations according to where boundary lines are located. Along these boundary lines, the appliance preferably undertakes a targeted improvement drive in order to detail the illustrated environment map, in particular in areas of adjacent floorings, and to minimize distortions. Image representations in the region of the boundary lines are particularly preferably combined with the previous image representations with increased weighting, or replace the previous image representations in order to obtain an improved illustrated environment map.

The invention further relates to a mobile self-propelled appliance, in particular a floor cleaning appliance such as a robot vacuum cleaner and/or robot sweeper and/or mopping robot, which comprises a camera and a processing facility and is configured so as to implement a method in accordance with the invention for creating the environment map of the surrounding area.

It is to be understood that in addition to the method and the appliance, a computer program product that comprises commands that when the program is being implemented prompt a mobile self-propelled appliance to implement the method in accordance with the invention is also included in the scope of this invention. Likewise, a computer-readable medium on which such a computer program product is stored is encompassed within the scope of this invention.

Any features, designs, embodiments and advantages relating to the method are also used in connection with the appliance, computer program product and computer readable medium in accordance with the invention, and vice versa.

Other features which are considered as characteristic for the invention are set forth in the appended claims.

Although the invention is illustrated and described herein as embodied in a method for creating an environment map, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic view of a mobile self-propelled appliance which is configured to implement a method in accordance with the invention for creating an environment map of a surrounding area;

FIG. 2 shows a flowchart of an exemplary embodiment of a method in accordance with the invention for the weighted combination of new (second) and previous (first) image representations;

FIG. 3 shows a schematic view of an exemplary embodiment of an environment map which is created using a method in accordance with the invention and which enables the user to reset;

FIG. 4 shows a schematic view of an exemplary embodiment of environment maps that are created using a method in accordance with the invention and that process the boundary lines; and

FIG. 5 shows a flowchart of an exemplary embodiment of a method in accordance with the invention for improving boundary lines.

### DETAILED DESCRIPTION OF THE INVENTION

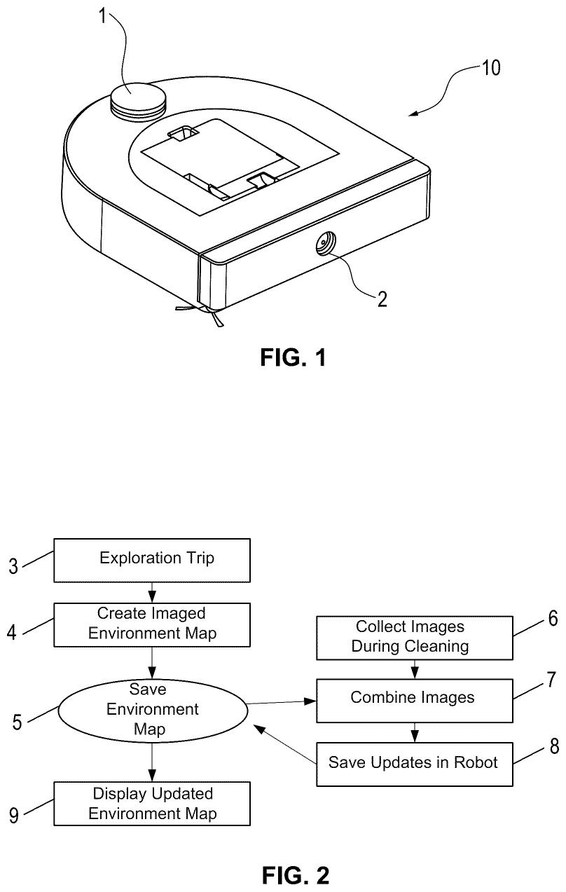

Referring now to the figures of the drawing in detail and first, in particular, to FIG. 1 thereof, there is shown a mobile self-propelled appliance 10 which is in particular a robot vacuum cleaner. The robot vacuum cleaner perceives its environment using various sensors, in particular using a LIDAR sensor 1, which is used to create an environment map with the contours of walls, objects and obstacles. In addition, the robot vacuum has at least one camera 2 that can capture objects in front of the robot vacuum and is used, for example, for object recognition and object classification. A field of view of the camera also captures sections of the flooring. These parts of the image representation can be used in order to perform a photomosaic floor mapping. The image contents are transformed using known parameters of the camera and its position and orientation on the robot vacuum in such a manner that they correspond to a bird's-eye view of the recorded flooring. Taking into account the robot position and robot orientation in relation to the environment map at the time of image recording, the corresponding floor area in the map representation can be filled with the image representations.

After commissioning, the robot vacuum is sent on an exploration trip by the user, during which the robot vacuum explores the environment, creates its environment map and at the same time integrates the floor area as an illustrated map into the environment map. During the exploration trip and during subsequent cleaning trips of the robot vacuum, the camera 2 captures areas of the floor again and again from changing directions with different lighting conditions and sometimes with different pitch angles. In order to increase the quality of the illustrated environment map during its creation and during its further continuous updates, in accordance with the invention weighted average value formations of previous and new image representations of the floor areas are generated. As a result, a consistent coherent floor representation in the environment map with low distortions and low illumination-dependent brightness changes can advantageously be generated.

In the present case, therefore, image representations for a prevailing floor area are not completely overwritten with new image representations, but rather previous first image representations are merged with new second image representations of the same floor area, resulting in stable image representations. The floor area is divided into individual grid cells. The weighted average value formation is applied, for example, individually to color channels or color settings. For this purpose, not only the previous first image representations, but also the number of all previous first captures of each grid cell in the robot vacuum, in particular in its processing device, are stored for each grid cell. The created averaged image representations are stored in the environment map and overwritten with updated averaged image representations. The prevailing averaged image representations are obtained from the previous (first) image representations of the grid cell multiplied by the number of previous (first) image representations for this grid cell, added to prevailing (second) image representations, divided by the number of image captures of this grid cell (number of first+second image representations).

Due to this weighted averaging of all image representations, distorted or blurred images are suppressed in a timely manner or have little effect from the beginning. The method results in an automatic averaging of illumination conditions and in an averaging of different perspectives. The number of previous first image representations is preferably limited to a maximum value, so that new image representations contribute a necessary weighting to the averaged image representation even after a plurality of image captures. Changes in the environment area are slowly incorporated into the environment map.

In order to further stabilize the environment map, the similarity of the new (second) and the previous (first) image representations can be taken into account. In this case, a weighting is performed with a weighting factor based on the number of previous image representations and the difference between the image representations. Alternatively, the similarity can be achieved on the basis of a distribution of all previous image representations with the aid of a standard deviation of the image representations.

FIG. 2 illustrates a flowchart for weighted average value formation. In a first method step 3, the robot vacuum cleaner performs an exploration trip and captures images of a floor area of a grid cell of the surrounding area with its camera (n-1), wherein (n-1) is the number of captured images and n is an integer greater than 1. These (n-1) images are transformed by the processing facility of the robot vacuum cleaner using known parameters of the camera, its position and orientation on the appliance, in such a manner that bird's-eye view (n-1)-first image representations of the floor area of the grid cell are generated. These (n-1)-first image representations are combined to form a first averaged image representation while performing weighted averaging.

In method step 4, the robot vacuum cleaner creates an imaged environment map based on the first averaged image representation of the floor area including the appliance position and orientation in relation to the environment map. The environment map and the first image representations, their number and the first averaged image representation are stored in the processing facility of the robot vacuum cleaner in method step 5.

In a cleaning job of the robot vacuum cleaner (step 6), the robot vacuum cleaner collects prevailing further images of the floor area of the same grid cell. In particular, at least one further image (n^{th} image), preferably a plurality of further images, is recorded from different positions. These prevailing further images are in turn transformed using known parameters of the camera, its position and orientation on the appliance in such a manner that at least one bird's-eye view second image representation of the floor area of the grid cell is generated.

In step 7, the robot vacuum cleaner combines the first and second image representations of the grid cell while performing a weighted averaging of all image representations, resulting in a second averaged image representation. This second averaged image representation and updated weighting factors are stored in the processing facility of the robot vacuum cleaner (step 8). In addition, the first averaged image representation that is stored in step 5 is overwritten with the second averaged image representation in the environment map. The revised and updated environment map is then displayed to the user in an app on their smartphone (step 9).

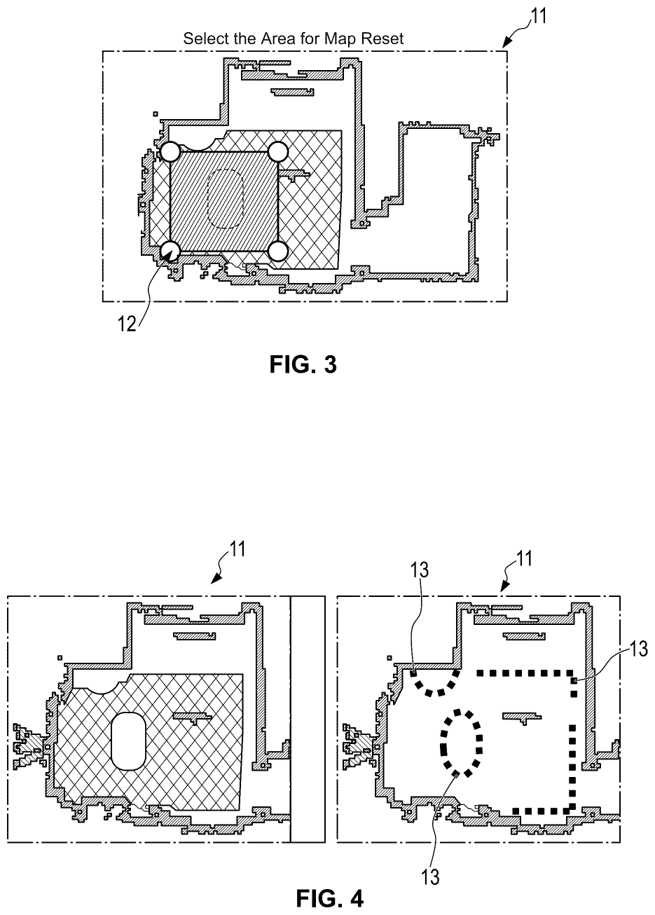

The user is preferably offered a function for resetting the illustrated environment map, in which the complete environment map does not necessarily have to be deleted, so that unchanged areas are still left in the map. In this case, the weighting factor n-1 is set to 1 or 0, so that new image representations have a greater influence or old image representations are overwritten once. Such a reset does not necessarily have to be applied to the entire floor area, but can be limited to only selected areas of the environment map via the function in the app. FIG. 3 illustrates such a reset area 12 in the environment map 11, with which the user is offered to overwrite previous map representations in an intended area 12 during the next cleaning trip.

The creation of the illustrated environment map can be further improved if the robot vacuum cleaner does not move transversely to boundary lines between floor surfaces of different floorings when capturing the images of the floor area, but along them. In order to recognize such boundary lines, the existing imaged environment map is processed by image processing means. Due to morphological operations such as region growing, erosion, dilation or closing, it is possible to open up contiguous areas of a same flooring. In a further or alternative step, edge extraction algorithms (for example, Canny algorithm or Sobel operator can be applied in order to establish striking boundary lines in the image representations. In a further, optional step, it is possible to determine geometric shapes (lines, circles) (for example, by a Hough transformation).

The detection of the aforementioned boundary lines is preferably improved by using additional sensors. For example, an installed ultrasonic sensor draws conclusions about the type of ground underneath. The detection of the inclination of the robot is performed by a built-in acceleration sensor or a gyroscope when driving over the edge of a carpet. The current consumption of the travel drives of the appliance, the brush roller motor, the side brush motors or another actuator in contact with the ground can provide information about changes in the ground underneath.

The robot vacuum cleaner evaluates the previous map image representations according to where boundary lines 13 are located, as illustrated, for example, in FIG. 4. The detected boundary lines 13 are illustrated by dashed lines in FIG. 4 (right-hand side). Along these boundary lines 13, after detecting these boundary lines 13 the robot preferably undertakes a targeted improvement drive in order to detail the illustrated environment map, in particular in areas of adjacent floorings, and to minimize distortions.

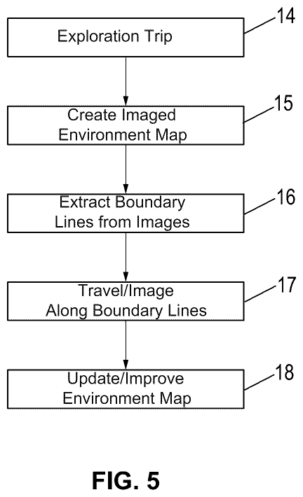

A sequence of the method for improving boundary lines 13 in the environment map is illustrated in FIG. 5. In step 14, the robot performs an exploration trip. The robot vacuum cleaner then creates an imaged environment map from the image representations of the camera, as explained, for example, in connection with the sequence method of the exemplary embodiment of FIG. 2 (step 15). The image representations are examined by means of image processing and boundary lines are extracted (step 16). The robot vacuum cleaner now travels along these extracted boundary lines and captures new images there for new image representations (step 17). In the last step 18, the environment map is improved with the image representations newly recorded at the boundary lines.

1. A method of creating an environment map of a surrounding area for an operation of a mobile self-propelled appliance by way of a camera of the appliance and a processing facility of the appliance, the method comprising the following steps:
a) capturing images of a floor area of a grid cell of the surrounding area using the camera;
b) transforming the images using known parameters of the camera, a position and an orientation of the camera on the appliance, to generate bird's-eye view first image representations of the floor area of the grid cell;
c) combining the first image representations while performing weighted averaging and inserting a first averaged image representation of the floor area into the environment map, including an appliance position and orientation in relation to the environment map;
d) capturing at least an n^{th} image of the floor area of the grid cell and transforming the n^{th} image into a second image representation;
e) combining the first and second image representations of the grid cell while performing a weighted averaging of all image representations; and
f) overwriting the first averaged image representation in the environment map with a second averaged image representation.

2. The method according to claim 1, which comprises dividing the surrounding area into a plurality of grid cells and performing method steps a) to f) in each of the grid cells.

3. The method according to claim 1, which comprises capturing the images during at least one of an exploration trip or a cleaning trip, and capturing the n^{th} image during a subsequent cleaning trip.

4. The method according to claim 1, which comprises capturing the images from changing directions, with different lighting conditions, and/or with different pitch angles.

5. The method according to claim 1, which comprises generating the second averaged image representation by multiplying the first image representations by a number of captured first image representations, adding a product of the multiplication to the second image representation, and dividing a sum of the addition by n.

6. The method according to claim 1, wherein the first and second image representations comprise at least one of the color channels or color settings to which the weighted averaging is applied.

7. The method according to claim 5, which comprises limiting the capturing of the images to a maximum value.

8. The method according to claim 5, which comprises enabling a reset to be performed in which a weighting for the first averaged image representation is set to 1 or 0 during a calculation of the second averaged image representation.

9. The method according to claim 1, wherein the second averaged image representation is influenced by similarities between the first image representations and the second image representation.

10. The method according to claim 1, which comprises moving the appliance along boundary lines of the floor area when capturing the images and the n^{th} image.

11. The method according to claim 1, which comprises processing the environment map by image processing in order to determine boundary lines of the floor area.

12. The method according to claim 1, wherein the floor cleaning appliance has at least one of the functionalities of a robot vacuum cleaner, a robot sweeper, or a mopping robot.

13. A mobile self-propelled appliance, which comprises at least one camera and a processing facility configured to create an environment map of a surrounding area in accordance with method claim 1.

14. The appliance according to claim 13, configured as a floor cleaning appliance being at least one of a robot vacuum cleaner, a robot sweeper, or a mopping robot.

15. A computer program product comprising commands that, when the program is executed by a mobile, self-propelled appliance, causes the appliance to implement the method according to claim 1.

16. A non-transitory computer readable data carrier having stored thereon the computer program product according to claim 15.
